(19) United States
(12) Patent Application Publication
(10) Pub. No.: US 2016/0049086 A1
(43) Pub. Date: Feb. 18, 2016

(54) AIRCRAFT SIMULATING APPARATUS FOR HELICOPTER HOVER SIMULATION

(71) Applicant: INFOCOPTER GMBH, Munich (DE)

(72) Inventor: Peter Mayr, Munich (DE)

(21) Appl. No.: 14/382,179

(22) PCT Filed: Feb. 4, 2013
(86) PCT No.: PCT/EP13/00334

§ 371 Date: Aug. 29, 2014

(30) Foreign Application Priority Data
Feb. 3, 2012 (EP) 12000721.6

(51) Int. Cl. G09B 9/08; G09B 9/30; G09B 9/20; G09B 9/46; G09B 9/16

(52) U.S. Cl. CPC G09B 9/085; G09B 9/46; G09B 9/16; G09B 9/203; G09B 9/30

(57) ABSTRACT

An aircraft simulating apparatus for helicopter hover simulation comprises a cabin containing in its interior a user interface with operating means adapted for simulating flight controls and at least one seat to accommodate a user in a pilot position to operate the flight controls, a carrying portion for supporting and moving the cabin, and a controller adapted to control-movements of the cabin in accordance with a hover simulation characteristics and dependent on the operation of the operating means for simulating flight controls. The carrying portion is adapted to move the cabin along translational movements in three spatial directions (X, Y, Z) and rotational movements around axes in three spatial directions (X, Y, Z), and includes a self-driven support vehicle adapted to perform movement on a ground surface at least along a forward direction (X′) and around one rotation axis (Z′) for rotating the forward direction (X′), and a robot arm supported by the support vehicle to be moved therewith while holding and supporting the cabin.

### CROSS-REFERENCE TO RELATED APPLICATIONS

Not applicable

### FIELD OF THE INVENTION

The present invention relates to an aircraft simulating apparatus, in particular to an aircraft simulating apparatus for helicopter simulation of hover flights for the purpose of pilot training, as well as to a self-driven transport apparatus.

### BACKGROUND OF THE INVENTION

Known aircraft simulating apparatuses for the purpose of pilot training have closed cabins with screens for virtual reality simulation. Some have additional hydraulic motion platforms for movement simulation. These are unsuitable for simulating real life operations of aircrafts, in particular in a near ground surrounding such as on airfields and hangars.

Moreover, hydraulic motion platforms are limited with respect to the spatial range of movements and therefore cannot perform realistic aircraft movements and accelerations. Rather, since the pilot is basically stationary, transport movements are faked by some rollback or washout algorithm of the motion platform.

FIG. 14 shows such aircraft simulating apparatus having a cabin representing a cockpit situated on a hydraulic motion platform that can be inclined forwards/backwards and sidewards within some limited angular range. A front part of the cabin is surrounded by a screen illuminated by one or more projectors for visually presenting a flight situation as seen by the pilot. Inclining the cabin by the hydraulic platform serves to simulate motion, wherein inclination and short range movements are used to simulate accelerations if the range of movement to be simulated extends the range of the hydraulic platform.

However, at least at a subconscious level, such approaches deviate from and severely disturb a human body's sense of orientation in space. In particular for experienced pilots, the discrepancy of the experienced motion and the visual expressions often causes kinematosis (motion sickness). Due to such effect, some extended recovery time is necessary between using such conventional simulating apparatus and controlling a real aircraft, so as to prevent danger of disorientation in space.

Therefore, despite significant efforts to improve the quality of simulations, training of pilots still primarily relies on real flight equipment. However, operating hours on real flight equipment are highly expensive and, moreover, suffer from serious availability constraints whenever introducing new types of aircrafts.

The situation is particular severe for training of helicopter pilots. Useful simulation equipment is not available for low level hovering (stationery or nearly stationery flight) and maneuvering close to ground. At the same time, sense of balance and sense of orientation, which are particular important for helicopter flight near ground, cannot be simulated with conventional simulating apparatuses for reasons explained above. Therefore, most time in helicopter pilot training is spent on low level flight, hovering, takeoff and landing. These situations are particularly critical in low visibility flight situations such as during landing of the helicopter when dust or snow are blown up, and where a pilot's recognition of ground contact and related control decisions are to be based on body feeling.

FIG. 15 is a top view of a typical maneuver sequence (“a” to “m”) to be exercised by training flights on a training airfield. The maneuver extends to more than 100 m×100 m and uses corresponding ground marks for orientation. The helicopter starts on the ground having position and orientation as shown in the upper left corner of the figure, lifts (a), rotates by 180° (b), hovers forward by 115 m (c), stops (d), rotates by 90° (e), hovers forward by 120 m (f), stops (g), lifts (h), hovers sidewards by 90 m (i), stops (j), rotates by 270° (k), hovers forward by 115 m (I), descends and lands (m).

FIG. 16 provides an illustrative comparison between the helicopter's real positional and angular coordinates when performing the maneuver sequence a-b-c-d-e-f-g-h-i-j-k-l-m (solid lines) and corresponding coordinates of a cabin moved on a hydraulic motion platform as in FIG. 14 simulating this maneuver (dashed lines). The differences between real and simulated movements are shown as striped areas. As can be seen, these differences extend over more than 100 m in x direction (in local coordinates of the cabin as shown in FIG. 1), more than 80 m in y direction, more than 4 m in z direction, more than 10° in roll and pitch movements and more than 200° in yaw direction. A typical maneuver from the above sequence lasts longer than 0.5 seconds. The realistic representation of the movement initiated by the hydraulic platform is impossible due to the limited maneuverability and the use of a wash-out algorithm. This inhibits the desired learning success. Further details on features and limitations of such motion simulators using hydraulic platforms and washout algorithms can be found in “Technical Report No. 159”, Max-Planck-Institut fuer biologische Kybernetik, February 2007.

Another quintessential part of pilot training relates to estimating physical distances to objects outside the aircraft. As illustrated in FIG. 14, a virtual reality presentation on a screen is observed from some substantially fixed distance, i.e. without adapting the observer's eye according to real physical distances of different shown objects. Thus, a virtual reality based trainer fails to train estimating distances to ground or objects outside the aircraft, but may rather induce some sense of disorientation.

Therefore, helicopter training elements such as the aforementioned maneuver sequence a-b-c-d-e-f-g-h-i-j-k-l-m must so far be trained in real helicopters.

According to another aspect, conventional self-driven transport of heavy loads is performed by specifically adapted vehicles such as track vehicles, while conventional robots suitable for movements in six degrees of freedom (DOF) are anchored at fixed positions. If both functions are to be performed, such as transporting a heavy load and then moving it along complex trajectories, such as ones requiring six degrees of freedom, the prior art typically uses separately first a self driven ground vehicle as a first apparatus for performing the transport operation, and—upon handover—a second apparatus such as a robot arm or other lifting equipment for performing said more complex movements. Typical examples for such operations occur during assembly of aircraft main components or heavy industrial engineering equipment, and/or related maintenance work involving transportation and complex movement of large and/or heavy objects. Alternatively, when moving heavy loads for aircraft maintenance, sometimes self-driven vehicles with lifting equipment are used. These are typically battery driven and adapted for a narrow range of operation. Further alternatively, trucks (first apparatus for performing the transport operation) are provided with lifting equipment (second apparatus) for loading/unloading or for supporting a movable platform as exemplified in FIG. 17. During operation of the lifting equipment, ground movements of the truck are prevented, typically by hydraulic legs. Controlling the movement of the second apparatus is effected separately from controlling the movement of the first apparatus, and user interfaces for inputting control commands are provided separately, by way of operating one or several from joy sticks, buttons, steering wheels, pedals or the like.

The control characteristics of known systems are linear and dynamically stabile in a sense that—within the operating range of the apparatus—a predetermined control command inputted by a user for movement in a certain direction will cause a corresponding movement in the certain direction, and in absence of such command inputted by a user, no movement in the certain direction will be effected.

All such and other prior art examples are limited with respect to range of operation and/or degrees of freedom for moving heavy objects. In most cases, such apparatuses are suitable only for narrow range of movements adapted for specific purposes. Consequently, the prior art faces great difficulties when having to fulfill a task of transporting heavy objects along distances exceeding the size of equipment used and also performing complex movements. In particular, so far, there is no combination of a self-driven vehicle with a six degree of freedom motion platform having a wide range of operation and offering a wide range of uses.

### SUMMARY OF THE INVENTION

The present invention has been made in consideration of the aforementioned problems.

According to a first aspect, an aircraft simulating apparatus is provided as defined in claim 1. The thereon dependent claims relate to further developments.

An aircraft simulating apparatus for helicopter hover simulation comprises a cabin containing in its interior a user interface with operating means adapted for simulating flight controls and at least one seat to accommodate a user in a pilot position to operate the flight controls, a carrying portion for supporting an moving the cabin, and a controller adapted to control movements of the cabin in accordance with a hover simulation characteristics and dependent on the operation of the operating means for simulating flight controls. The carrying portion is adapted to move the cabin along translational movements in three spatial directions and rotational movements around axes in three spatial directions, and includes a self-driven support vehicle adapted to perform movement on a ground surface at least along a forward direction and around one rotation axis for rotating the forward direction, and a robot arm supported by the support vehicle to be moved therewith while holding and supporting the cabin.

Thereby, the problems of the prior art can be overcome as follows. The carrying portion allows a realistic movement in all six degrees of freedom including unlimited ground movement. Thereby, physical movements close to ground can be performed in a manner close to reality, according to the simulated flight and without use of washout algorithm. Hence, a realistic body feeling, sense of balance, and orientation can be experienced and trained as identically occurring in real flight situation.

Moreover, when the cabin further comprises a window for viewing outside, the pilot seat, the window and the robot arm are preferably arranged such that a connection between robot arm and cabin is not visible from the seat through the window, and when further preferably the outside of the cabin is shaped in correspondence with the aircraft to be simulated, the training can be performed in realistic circumstances without virtual reality simulation. This at the same time allows a highly realistic, highly economic, and safe training setup. Moreover, the cost and safety requirements as well as regulatory constraints of real flight lessons can be saved.

More specifically, as shown in FIG. 6, a user sitting on the pilot seat of the aircraft simulating apparatus of the present invention, experiences the full viewing angle of the aircraft to be simulated, including correct distances between user's eye and ground. Even skids can be provided at correct positions of the aircraft, visible from the seat through the window, and physically effective when touching ground.

Other objects and advantages will become apparent from the subsequent description, the claims and the figures.

### BRIEF DESCRIPTION OF THE DRAWINGS

FIG. 1 illustrates a perspective view of the cabin of the aircraft simulating apparatus according to an embodiment of the present invention.

FIG. 2 illustrates a perspective view of the aircraft simulating apparatus and the self-driven transport apparatus according to an embodiment of the present invention.

FIG. 3 illustrates a bottom view of the self-driven support vehicle of the aircraft simulating apparatus and the self-driven transport apparatus according to an embodiment of the present invention.

FIG. 4 illustrates a block diagram of components of the aircraft simulating apparatus according to an embodiment of the present invention.

FIG. 5 illustrates a block diagram of a controller and its operation within the aircraft simulating apparatus according to an embodiment of the present invention.

FIG. 6 illustrates a side view of the aircraft simulating apparatus according to an embodiment of the present invention.

FIG. 7 illustrates perspective views of plural operation states of the aircraft simulating apparatus according to an embodiment of the present invention.

FIG. 8. illustrates a side view of the aircraft simulating apparatus according to an embodiment of the present invention, and a block diagram of a controller thereof, as well as schematic flight paths.

FIG. 9 illustrates side views of plural operation states of the aircraft simulating apparatus according to an embodiment of the present invention, and corresponding states of flight controls.

FIG. 10 illustrates side views of plural operation states of the aircraft simulating apparatus according to an embodiment of the present invention.

FIG. 11 illustrates a top view of a training area in which the aircraft simulating apparatus according to an embodiment of the present invention can be used.

FIG. 12 illustrates typical influences of surrounding area on a helicopter in front view which can be simulated by the aircraft simulating apparatus according to an embodiment of the present invention as dynamic inputs of hover simulation characteristics.

FIG. 13 illustrates side views of plural operation states of the aircraft simulating apparatus according to an embodiment of the present invention.

FIG. 14 illustrates a side view of a prior art aircraft simulating apparatus.

FIG. 15 illustrates a top view of a typical maneuver sequence to be exercised by real helicopter training flights on a training airfield.

FIG. 16 illustrates changes of positional and angular coordinates of a cabin of a helicopter when performing the maneuver sequence of FIG. 15 (solid lines), and corresponding coordinates of a prior art aircraft simulating apparatus (dashed lines).

FIG. 17 illustrates a side view of a prior art self-driven transport apparatus.

### DETAILED DESCRIPTION

In the following, an aircraft simulating apparatus according to a first aspect will be described with reference to the figures.

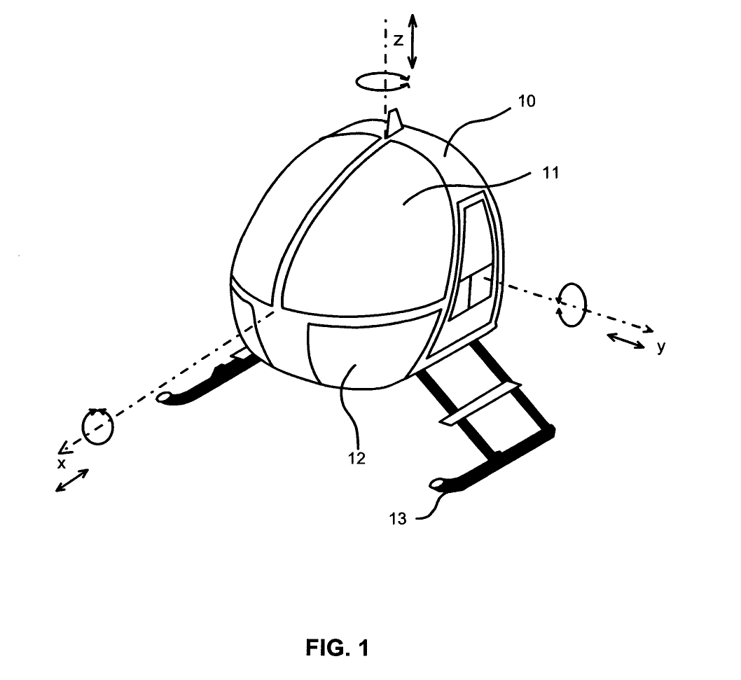

FIG. 1 illustrates a perspective view of the cabin 10 of the aircraft simulating apparatus according to an embodiment of the present invention. The cabin 10 can be moved in six degrees of freedom, namely along translational movements in three linearly independent spatial directions and rotational movements around axes in three linearly independent spatial directions. In particular, said translational movements are forward/backward (X), sideward (Y), and vertical (Z) movements and said rotational movements are roll (around X axis), pitch (around Y axis), and yaw (around Z axis), all defined with respect to the cabin. As further shown in FIG. 1, the coordinate system of the cabin 10 changes its global orientation in space.

The cabin 10 may be formed of metal or any other robust material, which may be same or similar to materials used for forming aircraft fuselages. The cabin 10 includes in its interior a user interface 14 with operating means adapted for simulating flight controls and at least one seat to accommodate a user in a pilot position to operate the flight controls.

The cabin 10 can further comprise a window 11, 12 for viewing outside. In such case, the pilot seat, the user interface 14, and the window 11, 12 are arranged in correspondence with the aircraft to be simulated. Moreover, the pilot seat, the window 11, 12, and the robot arm 20 of the aircraft simulating apparatus are arranged such that a connection between robot arm 20 and cabin 10 is not visible from the seat through the window 11, 12. Preferably, the outside of the cabin 10 is further shaped in correspondence with the aircraft to be simulated.

The aircraft to be simulated can be a plane or a helicopter. In the latter case, the flight controls comprise cyclic stick, yaw pedals, and collective pitch, and the outside of the cabin 10 comprises skids 13 and/or fuel probes. Moreover, the window 11, 12 may comprise an upper 11 and a lower part 12, wherein the skids 13 are viewable from the seat at least through the lower part 12 of the window.

Rather than a window 11, 12, the cabin 10 may alternatively comprise a screen for virtual outside view.

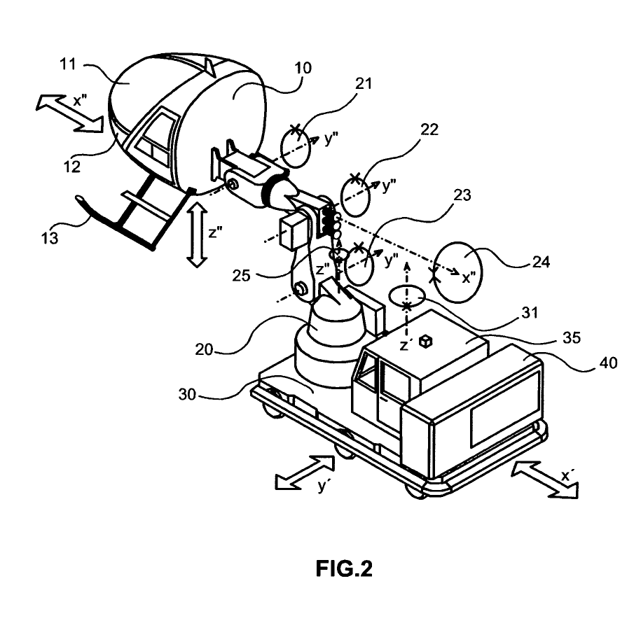

FIG. 2 illustrates a perspective view of the aircraft simulating apparatus or the self-driven transport apparatus as the carrying portion of the aircraft simulating apparatus with a cabin 10 as the object to be moved.

As shown therein, the aircraft simulating apparatus comprises a carrying portion 20, 30 for supporting and moving the cabin 10. The carrying portion 20, 30 is adapted to move the cabin 10 along six degrees of freedom as illustrated in FIG. 1. It includes a self-driven support vehicle 30 adapted to perform movement on a ground surface at least in forward/backward direction X′ and around one rotation axis Z′ perpendicular to the ground surface. The carrying portion 20, 30 further includes a robot arm 20 supported by the support vehicle 30 to be moved therewith while holding and supporting the cabin 10. Hence, movement of the cabin 10 results from combining the movements of the support vehicle 30 and the robot arm 20.

In an embodiment specifically illustrated in FIG. 2, the robot arm 20 is capable of translational movements along a forward direction X″, and a vertical direction Z″, as well as rotational movements around axes in three spatial directions X″, Y″, Z″, and the support vehicle 30 is capable of movements along a forward direction X′, a sideward direction Y′, and a rotation around an axis Z′ perpendicular to the ground surface. The coordinate systems of the robot arm 20 and the support vehicle 30 depend on their global orientation in space. In general, they may differ from each other as well as from the coordinate system of the cabin 10. In the specific situation drawn in FIG. 2, all parts of the aircraft simulating apparatus are arranged such that their coordinate systems correspond to each other. In this situation, the X, X′, and X″ axes correspond to forward and backwards movements, the Y, Y′, and Y″ axis corresponds to sideward movements, and the Z, Z′, and Z″ axes correspond to vertical movements. Rotations around these axes correspond to roll, pitch, and yaw movements, respectively.

In such case, movement in sideward direction is solely performed by the support vehicle 30 and movement in forward/backward direction is predominately performed by the support vehicle 30. Roll movement of the cabin 10 is performed by a rotation along axis 24 (X″) of the robot arm 20. Vertical and pitch movements of the cabin 10 are performed by a combination of rotations along the axes 21-23 (Y″) of the robot arm 20 and some compensating movement in forward/backward direction of the support vehicle 30. In case of pitch movement, this requires at least one rotation, whereas movement in vertical direction requires at least two rotations. Yaw movement is performed by a combination of rotations along axis 25 (Z″) of the robot arm 20 and axis 31 (Z′) of the support vehicle 30, as well as sideward movement of the support vehicle 30.

More generally, any movement of the cabin 10 can be performed by a suitable combination of movements along the degrees of freedom of the robot arm 20 and the support vehicle 30.

The aircraft simulating apparatus can have mounted thereto a power supply unit 40 comprising a fuel container and power source means for generating power to operate the support vehicle 30 and the robot arm 20 from fuel contained in the fuel container.

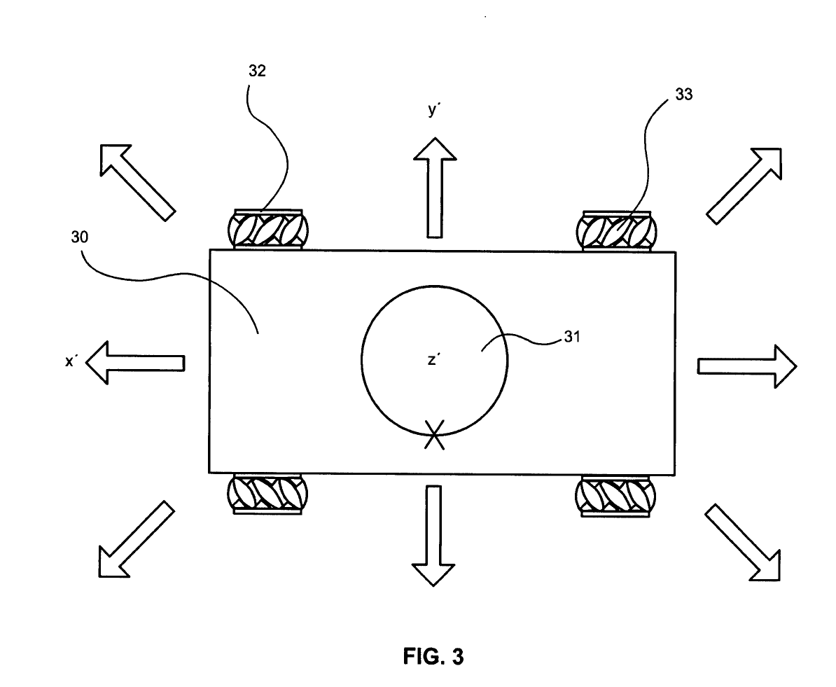

FIG. 3 illustrates a bottom view of the self-driven support vehicle 30 of the aircraft simulating apparatus or the self-driven transport apparatus according to an embodiment in which forward and sideward movements are implemented by plural roll movements of the support vehicle 30 around axes in different directions.

In this embodiment, the support vehicle 30 comprises individually drivable metal wheels 32 having disposed on the running face of each wheel plural smaller rolls 33 which are not actively driven and oriented diagonally with respect to the directions of wheel axis and running face. Any desired forward, sideward, and yaw movement of the support vehicle 30 can be achieved by a suitable combination of different rotation directions and rotation speeds of the metal wheels 32, wherein said desired movement is effected by respective passive rotations of the rolls 33.

Alternatively, the support vehicle can be an air cushion vehicle or a track vehicle in which sideward movement is implemented by a combination of rotation and forward movements.

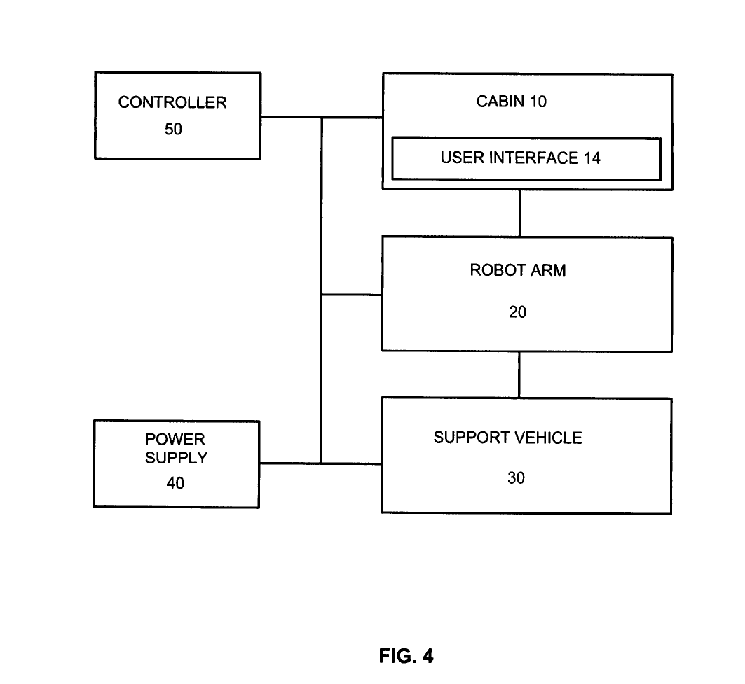

FIG. 4 illustrates a block diagram of components of the aircraft simulating apparatus according to an embodiment of the present invention. As shown therein, the aircraft simulating apparatus comprises a cabin 10, a robot arm 20, a self-driven support vehicle 30, a power supply unit 40, and a controller 50.

The cabin 10 can have a length in the range from 1500 mm to 4000 mm, a width in the range from 700 mm to 2500 mm, a height in the range from 1500 mm to 3000 mm, and a weight in the range from 200 kg to 1000 kg, preferably 400 kg or less.

The robot arm 20 can have a vertical range between 3000 mm and 7000 mm, a horizontal range between 2000 mm and 4000 mm, a weight in the range from 2000 kg to 4000 kg, power consumption in the range from 5 kW to 15 kW, and can allow rotations of more than 360°.

The self-driven support vehicle 30 can have a length in the range from 2400 mm to 4500 mm, a width in the range from 1000 mm to 3000 mm, a weight in the range from 2000 kg to 8000 kg, a load capacity in the range from 2500 kg to 8000 kg, preferably 5000 kg or more, and power consumption in the range from 10 kW to 50 kW.

The power supply unit 40 comprises a fuel container and a power source means. The power source means comprises a fuel cell or an electric generator combined with a combustion engine or a turbine. The power supply unit 40 provides electric power to the cabin 10, in particular to the therein contained user interface 14, to the robot arm 20, the support vehicle 30, and the controller 50. The power supply unit may preferably provide a continuous power supply of 18 kW or more, and may further preferably comprise a rechargeable battery for balancing changes in power consumption.

The controller 50 is f or controlling movements of the cabin 10 via the robot arm 20 and the support vehicle 30, dependent on the operation of the operating means for simulating flight controls.

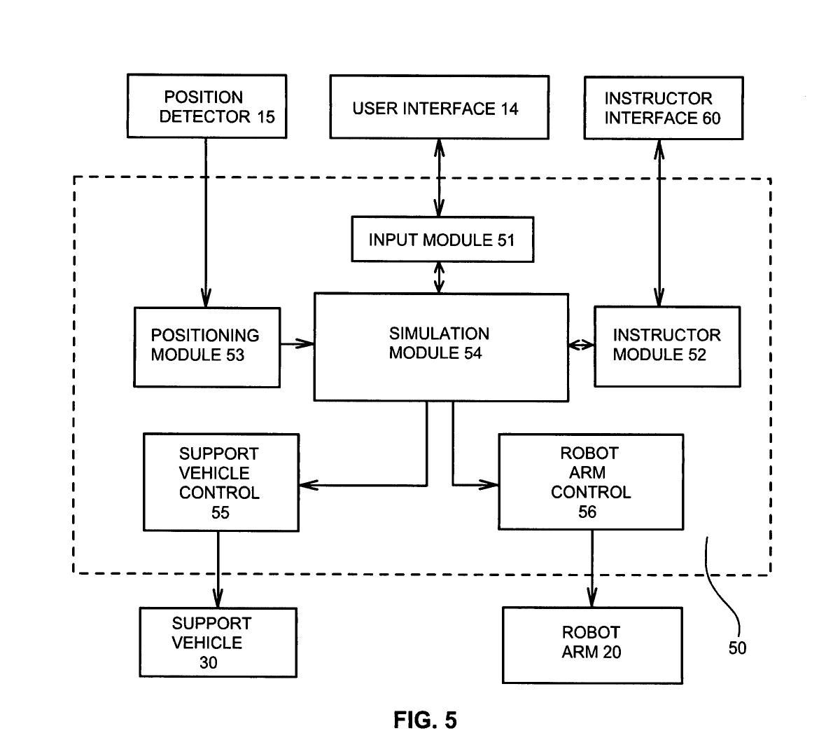

FIG. 5 illustrates a block diagram of the controller 50 and its operation within the aircraft simulating apparatus. As shown therein, the controller 50 comprises an input module 51, an instructor module 52, a positioning module 53, a simulation module 54, a support vehicle control module 55, and a robot arm control module 56.

The input module 51 detects operation states of the operating means for simulating flight controls belonging to the user interface 14 in the cabin 10. Such operating states may be positions of collective pitch, cyclic stick, and yaw pedals. The resulting operation state data is transmitted to the simulation module 54.

The instructor module 52 allows an instructor, via an instructor interface 60, to adjust simulated aircraft characteristics, simulated malfunctions, and simulated aerodynamic environment, all effecting movement characteristics of the aircraft to be simulated. Examples thereof are direction and strength of wind, shape of landscape, and a load to be carried by the aircraft. Moreover, malfunctions in the engine of the aircraft can be simulated.

The instructor interface 60 can be mounted on the support vehicle 30 or can be located at some stationary position outside the aircraft simulating apparatus. The instructor module 52 of the controller 50 receives instructor commands from the instructor interface 60 and transmits them to the simulation module 54.

The positioning module 53 receives position information from a position detector 15 such as a GPS receiver. The position detector 15 can be located in the cabin 10 to provide position information of the cabin in a global coordinate system. The positioning module 53 transmits such information to the simulation module 54.

The simulation module 54 calculates movements of the aircraft to be simulated dependent on the information received from the input module 51, the instructor module 52, and the positioning module 53 and provides movement instructions for the support vehicle control module 55 and the robot arm control module 56. Moreover, the simulation module 54 transmits user and instructor information to the input module 51 and the instructor module 52 for display on the user interface 14 and the instructor interface 60, respectively.

The calculation of movement instructions includes consideration of current positions and orientations of the cabin 10, the robot arm 20, and the support vehicle 30 in a global coordinate system and transformations with respect to local coordinates of such parts of the simulating apparatus. For example, a user operation via the operating means for simulating flight controls always refers to the coordinate system of the cabin 10 which can significantly differ from the support vehicle 30 in an arbitrary flight situation.

The support vehicle control module 55 and the robot arm control module 56 receive movement instructions from the simulation module 54 and determine there from respective necessary movements of the support vehicle 30 and the robot arm 20. Moreover, said modules comprise master control means adapted to override control by user operation of the operating means for simulating flight controls so as to confine forward/backward and sideward movements of the transport vehicle to a predetermined territory and confining rotational movements via the robot arm so as to prevent the transport apparatus from tilting.

The above described functions enable the controller 50 to affect the movement of the cabin 10 dependent on at least one of simulated aircraft characteristics, simulated malfunctions, and simulated aerodynamic environment.

As an illustrative example, the helicopter simulating apparatus may be used on premises of an airport with wide areas of open space occasionally exposed to strong wind, as well as arrays of large buildings (hangars) arranged at distance to each other and creating slipstream on their respective lee sides. Flying near ground in and out of such slipstreams poses particular challenges which may be trained with the flight simulating apparatus according to the present invention. For simulation purposes, the aerodynamic environment including slipstreams can for instance be modeled in a coordinate system matching the ground and fed into the simulation system 54 to affect the cabin's movements dependent on the position thereof within said coordinate system.

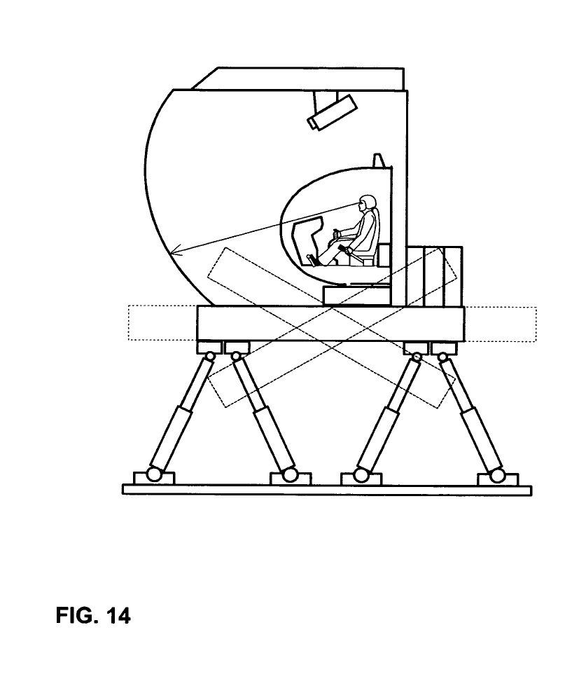

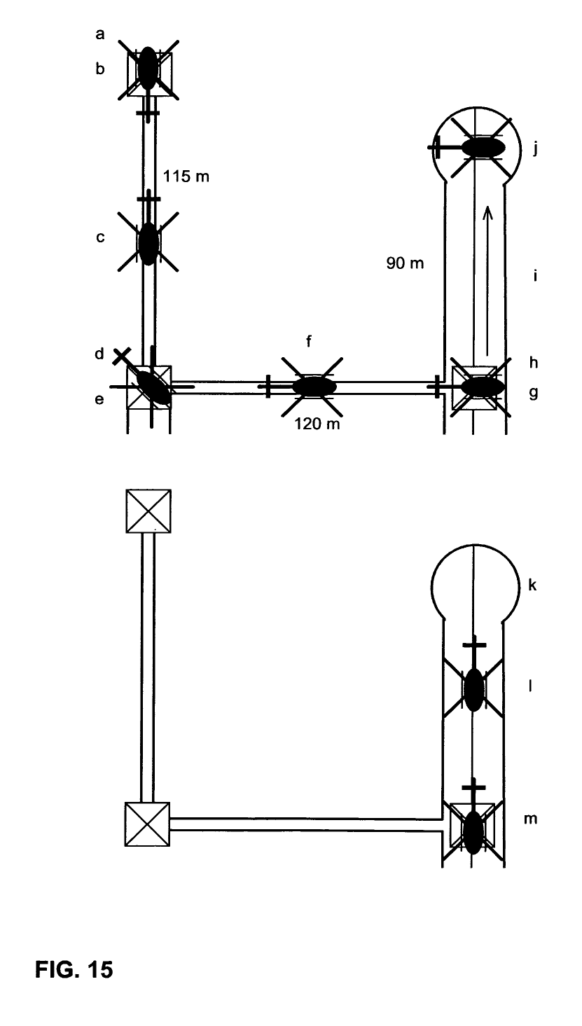

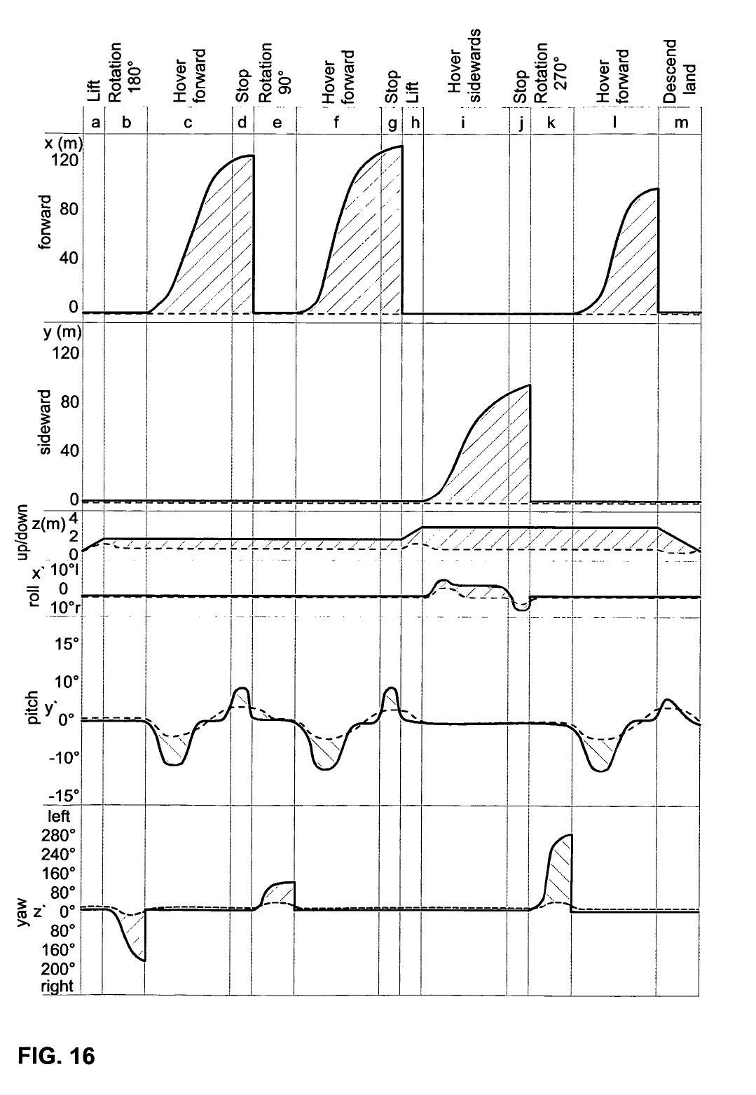

To give a specific example, the helicopter simulating apparatus according to the present invention may be used in connection with a training ground as shown in FIG. 15 to train the same maneuver sequence (“a” to “m”) as explained before, thereby replacing corresponding training flights of real helicopters. The helicopter simulating apparatus according to the present invention controls movements of the training cabin in accordance with hover simulation characteristics, i.e. it can reproduce movements of a real helicopter under realistic modeling assumptions. Therefore, aspects relating to sense of orientation in space can be effectively trained. Problems of the prior art caused by simulating cabin movements by using a hydraulic motion platform as shown in FIG. 14 explained before and in connection with FIG. 16 do not occur.

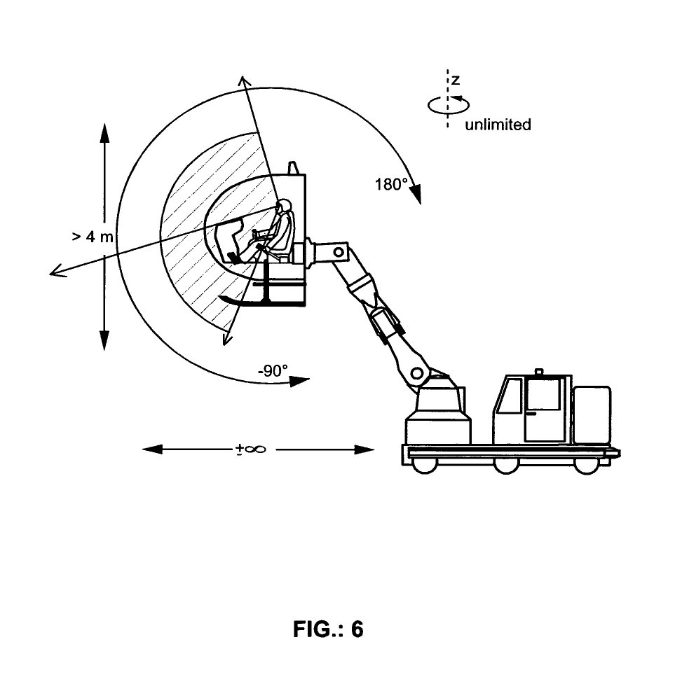

FIG. 6 shows a side view of the aircraft simulating apparatus according to an embodiment of the present invention and illustrates ranges of possible movements. In a preferable configuration, the range of lateral movements (x, y directions) is unlimited, the range of vertical movements (z direction) is larger than 4 m, the effective pitch resulting from plural rotational axes (21, 22, 23 in FIG. 2) of the robot arm ranges from −90° to 180°, the roll range (around axis 24 in FIG. 2) is larger than 360°, and the yaw range (around axis 31 in FIG. 2) is unlimited. These parameters allow simulating hovering maneuvers with great degrees of freedom and hence a high degree of realism. Since the cabin is supported from a direction outside the pilots sight, here from the back side of the pilot seat, the range of the pilots field of view is limited only by the cabin itself. Contrary to conventional simulators using hydraulic platforms and virtual reality projections, unlimited downward views towards skids and ground can be realized.

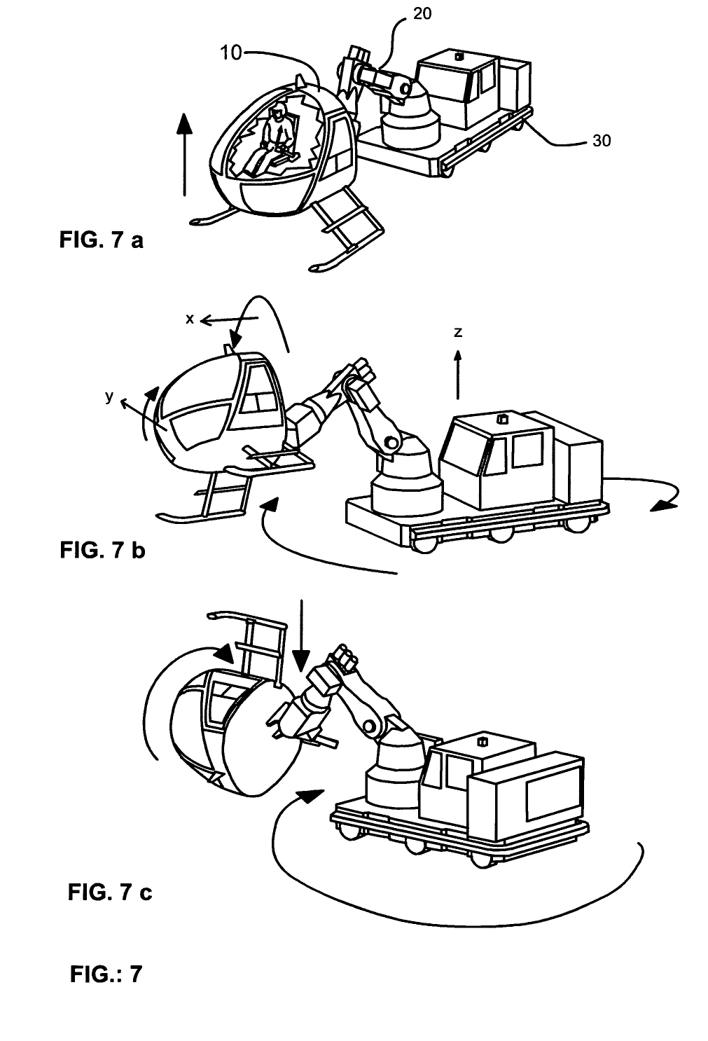

Next, the underlying hover flight situation to be simulated is described in greater detail with reference to FIGS. 7ff.

FIG. 7 illustrates a typical situation of a rookie pilot trying to take off with a helicopter as simulated with the aircraft simulating apparatus. When the pilot lifts the helicopter by pulling the collective stick (see FIG. 7a), the torque effect of the main rotor causes rotation around the z-axis of the helicopter (motion of self-driven support vehicle 30 in FIG. 7b). The helicopter further rotates around x and y axes depending on its center of gravity (see also FIG. 7b). If the pilot does not compensate such movements of the helicopter by active operation of the operating means, he will inevitably crash head-over as shown in FIG. 7c. The aircraft simulating apparatus of the present embodiment would allow simulating such crash in principle. Considering safety requirements for human pilots and equipment, crashes are preferably prevented. In one embodiment, a master control means is provided for confining movements to a safe range, by overriding control by user operation.

As can be denoted from the above case, a helicopter hovering in low level flight such as during landing or take-off has hover simulation characteristics which comprises that in the absence of any operation of the operation means, movement of the cabin 10 is effected, and/or a predetermined operation of the operation means for movement in a certain direction causes movement of the cabin 10 in a further direction. The former corresponds to a dynamic unstable flight situation in which the aircraft, and particularly the cabin 10, is moved away from a desired flight position even without user operation of the operation means. Hence, for retaining the desired flight position, the user is required to actively compensate such movement by operation of the flight controls. The latter corresponds to a nonlinear control situation in which a desired operation can be superposed by undesired movements.

The aircraft simulating apparatus of the present embodiment includes a controller which allows simulating such hover flight situation which will now be described with reference to Fig. Ba. The controller 50 has as its input a number of nonlinear chaotic input parameters as shown in the following table.

| | |
|---|---|
| Input | Mainly influenced by |
| Torque | Collective control position |
| Center of gravity | Place of load |
| | Seating of passengers |
| | Amount of fuel |
| Weight | Payload |
| | Number of passengers |
| | Amount of fuel |
| Dynamic roll-over tendency | Tail rotor thrust |
| | Crosswinds Slope |
| | Center of gravity |
| | Cyclic control position |
| | Collective control position |
| | Pilot induced turbulence |
| Atmosphere | Weather Wind |
| | Altitude |
| | Precipitation |
| Malfunctions | Programmed malfunctions |
| | Random malfunctions |
| Obstacles | Buildings |
| | Trees Hills |
| | Poles Etc. |

Said chaotic input parameters generally depend on position and orientation of the cabin in space (e.g. center of gravity, dynamic roll-over tendency, obstacles), prior user operations (e.g. torque, dynamic roll-over tendency), as well as predetermined and/or random additional effects (e.g. center of gravity, weight, atmosphere, malfunctions). The position and orientation of the cabin 10 can be determined by the position detector 15 and may comprise the height above ground, the horizontal position with respect to outside obstacles, and three angles for defining the rotation state. Based on such inputs, the controller 50 calculates movements of the aircraft to be simulated, in accordance with hover characteristics such as dynamic unstable flight characteristics, by using a flight simulation software.

Suitable flight simulation software for calculating realistic aircraft movements in accordance with hover simulation characteristics is commonly available. Further details on how to determine such movements can be found in in “Learning to fly helicopters” by R. Randall Padfield, TAB Books, McGraw Hill, USA, 1992. So far, the calculated movements are typically presented to the user only on screens for virtual reality simulation. Sometimes additional hydraulic motion platforms are used for performing movements in a strongly limited range.

In one operation mode, the controller of the present embodiment can control movements of the cabin 10 in full correspondence with the calculated movements of the aircraft to be simulated by combined movements of the robot arm 20 and the self-driven support vehicle 30 of the carrying portion. In further operation modes of the aircraft simulating apparatus, e.g. for training of inexperienced pilots, the calculated movements can be modified, for instance by decreasing or slowing, in the motion control of the cabin, or calculated movement features can be implemented only selectively. Further alternatively, predetermined movement paths might be used to overrule controls, for instance for reaching predetermined positions or demonstrating targeted flight paths to be trained. In any of such modes, the pilot may be provided with additional signals such as warnings and/or instructions on how to operate flight controls. A flight history may be recorded, e.g. for playback with a trainer. A master control may be provided for selecting among the aforementioned modes.

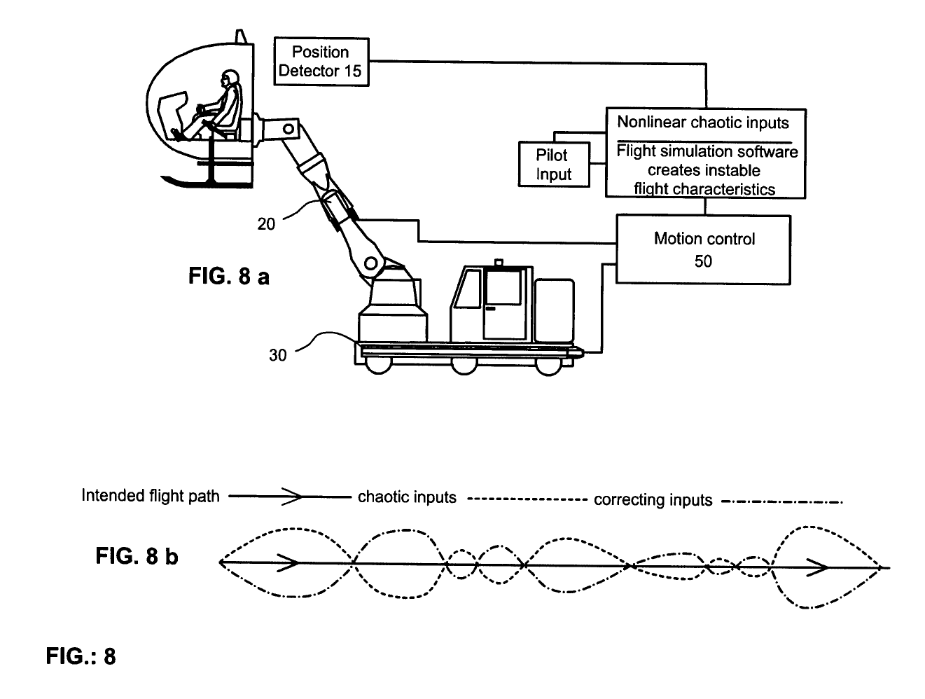

The resulting movements of the cabin 10 can comprise translations, rotations, and accelerations as performed by a realistic helicopter which includes that the movement of the cabin deviates from the intended flight path as shown schematically in FIG. 8b. The pilot is required to provide correcting inputs to compensate such deviations in order to keep the aircraft close to the intended flight path.

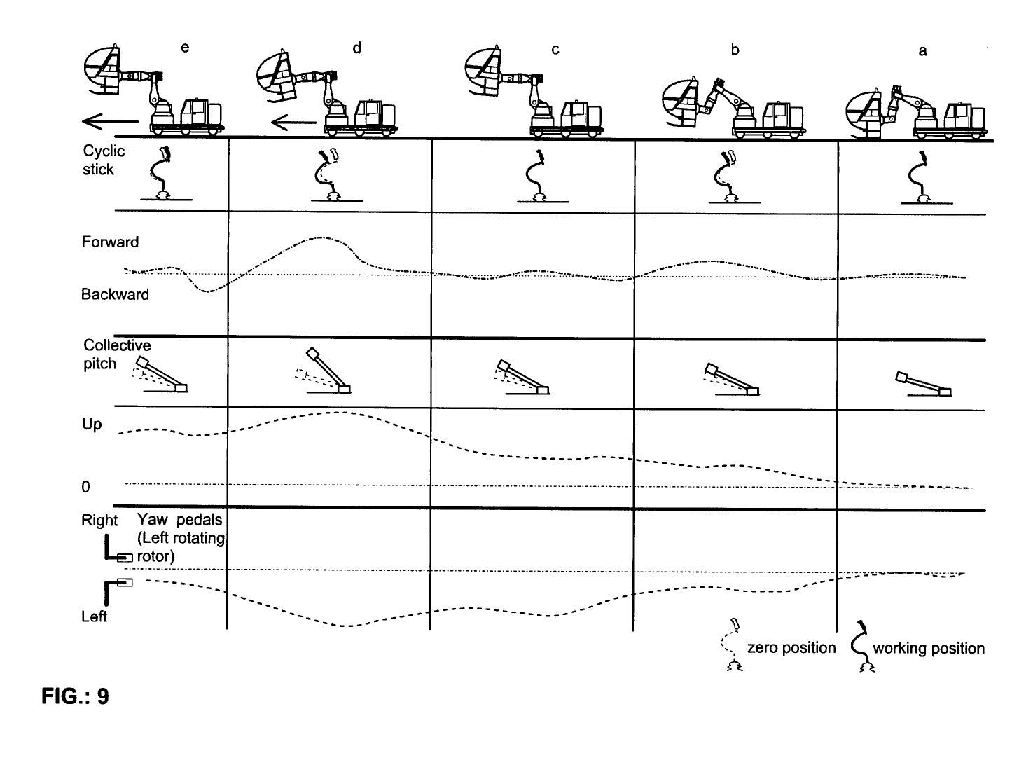

FIG. 9 illustrates such correcting inputs by specifying the actually required controls of cyclic stick, collective pitch, and yaw pedals for taking off with a helicopter (case a to c) and starting forward flight close to ground (cases d and e) while avoiding a crash as illustrated in FIGS. 7a-c.

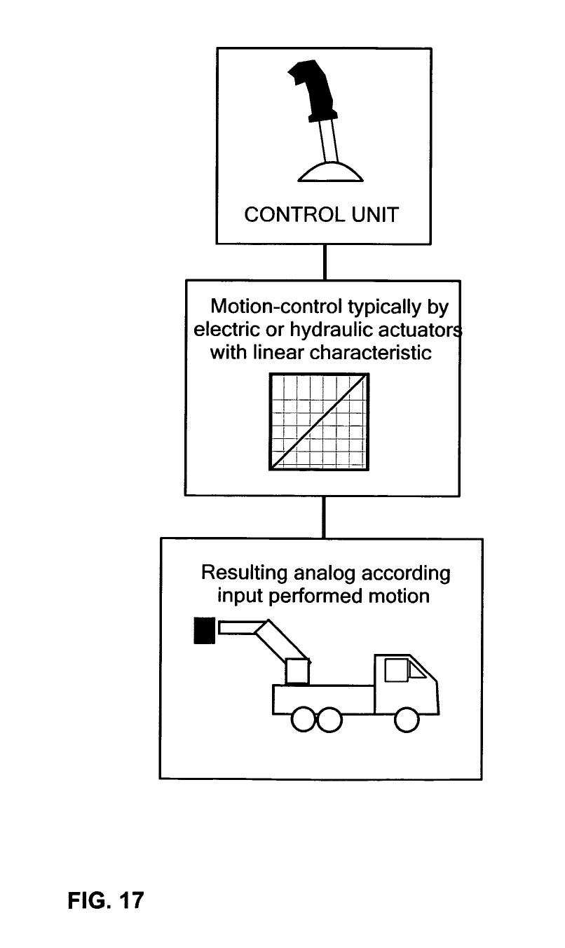

These correcting inputs effect movements of the cabin 10 in a way completely different from the conventional carrying portion with self-driven support vehicle and robot arm shown in FIG. 17, in which movements of an object carried by the robot arm directly reflect the input to the control unit. In contrast thereto, in the presently described simulation, the user input itself also enters into the above described chaotic inputs (e.g. torque and dynamic roll-over tendency depend on collective and cyclic control positions), such that the control input becomes highly nonlinear.

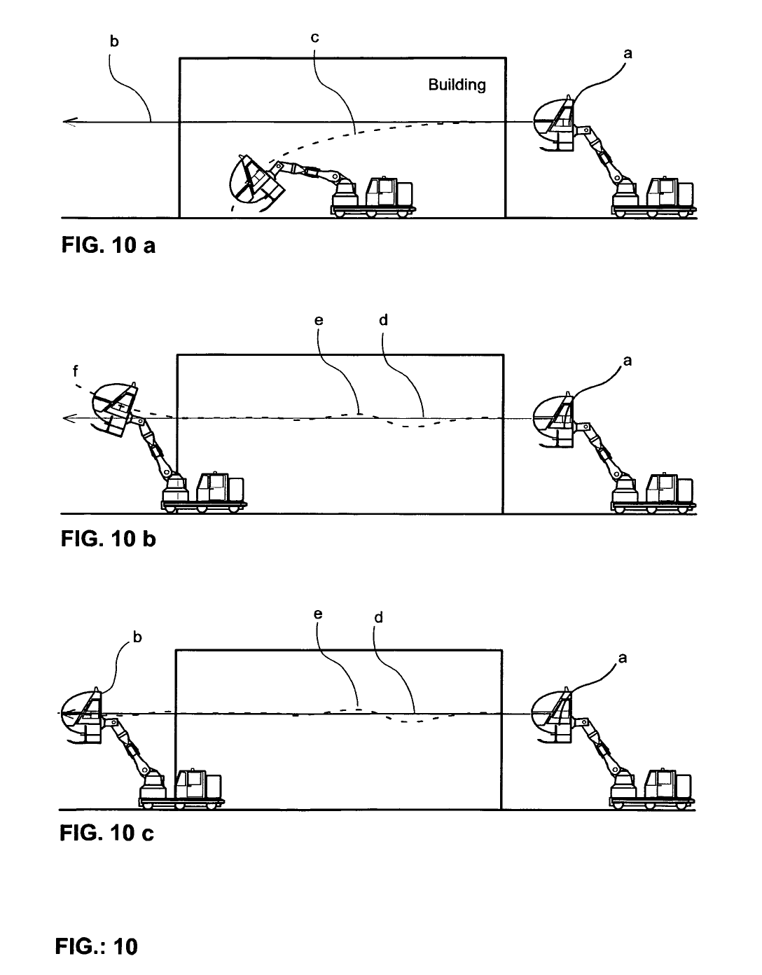

FIG. 10 illustrates a more complicated flight situation which can be simulated with the aircraft simulating apparatus of the present embodiment. When a helicopter with left rotating rotor shall pass a building B located to its right hand side in low lever hover flight (i.e. moving from point a to b as shown in FIG. 10a), the building effects the air stream of the rotor in such a way that, without performing any correcting inputs, the helicopter would tilt forward and crash into ground as shown in point c of FIG. 10a. For avoiding such crash, the pilot is required to compensate the unintended movement by tilting the helicopter backward (resulting in a slight upward movement as indicated in point d of FIG. 10b, followed by a slight further correction as indicated in point e). When passing the building while pulling the helicopter upward for compensating the effect of the building, the helicopter would abruptly move upward once the end of the building is reached as shown in point f of FIG. 10b. Hence, a further compensating downward movement of the pilot is required for flying the intended path from point a to b as shown in FIG. 10c.

The aircraft simulating apparatus of the present embodiment allows to simulate such complicated flight situation by providing a carrying portion comprising the robot arm 20 and the self-driven support vehicle 30 which is configured such that movements of the cabin are performed by a superposition of movements along the degrees of freedom of the robot arm 20 and of the support vehicle 30 which are preferably carried out simultaneously. In one embodiment, the robot arm 20 provides translational movements in vertical direction of at least 2 m, preferably at least 4 m, as well as rotational movements around axes in three spatial directions. The self-driven support vehicle 30 provides ground movements with at least one of ranges of 100 m or more, speeds of 20 km/h or more, and accelerations of 1 m/s2 or more, as typical for helicopters in low level flight. Combined movements of the robot arm 20 and the support vehicle 30 can provide accelerations of 1 g or more.

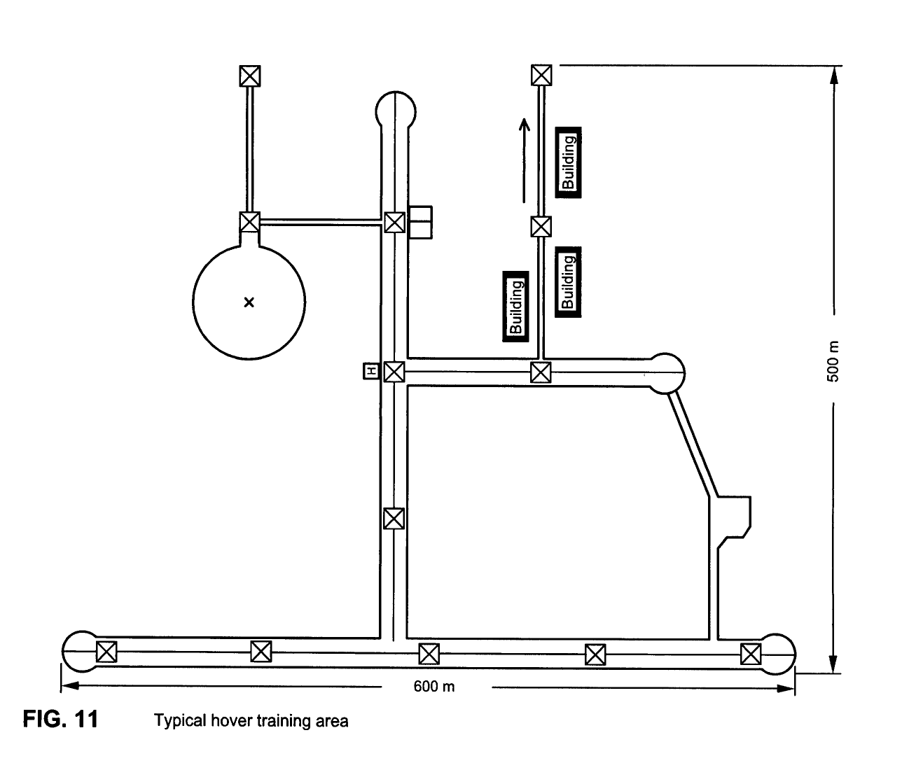

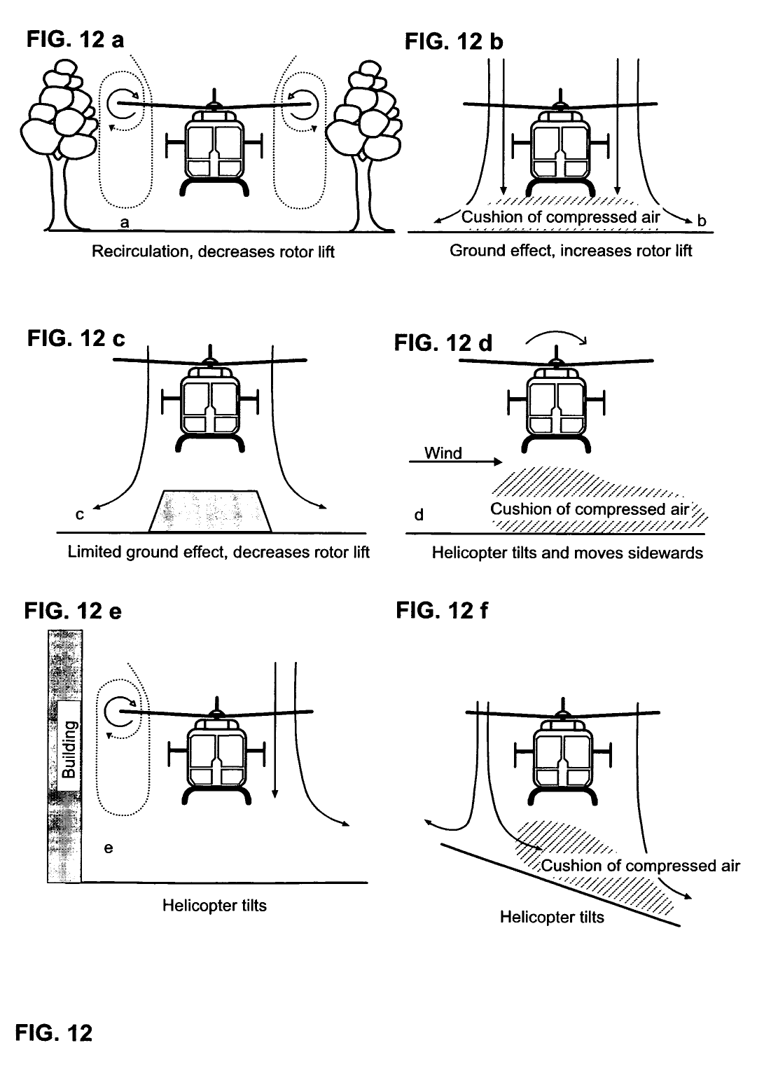

The above mentioned ranges of horizontal movement allow to simulate all possible training activities on a typical hover training area extending by hundreds of meters as shown in FIG. 11. Moving the cabin 10 along translational movements in three spatial directions and rotational movements around axes in three spatial directions allows to simulate all major influences of surrounding area as illustrated in FIG. 12, or even combinations thereof.

More specifically, FIG. 12 shows: (a) flight through large objects on both sides, (b) approaching ground, (c) flying over small ground elevations, (d) side wind, (e) flight passing close to a building, and (f) flight over sloped ground.

Correspondingly, the controller overlays, as part of the hover simulation characteristics, one of the following dynamic inputs: vertical downward movement, for simulating loss of lift between two large objects such as trees or buildings, or above small ground elevations such as ground elevations having a lateral size corresponding to the landing width of helicopter skids (typically 2200-2500 mm) or less; vertical upward movement, for simulating increase of lift close to ground such as in a height corresponding to a rotor diameter (typically 10-12 m) or less; roll of the cabin in combination with sideward drift for simulating side wind or sloped ground; a sequence of downward and upward pitch, or upward and downward pitch, of the cabin, for simulating flight passing close to a large object such as a building, typically having a height of 4 m or more, such effect being most effective in a distance corresponding to the rotor diameter or less; and a combination of half turn roll and yaw of the cabin, for simulating uncorrected take-off.

Presuming a stable flight trajectory controlled by the pilot, such overlaid dynamic inputs introduce respective destabilizing movements that require additional counteraction by the pilot to maintain a stable trajectory. In absence of such additional counteraction, the trajectory is destabilized.

The overlaid dynamic inputs according to the present invention can be activated in a variety of manners, depending on the scenario of influences of surrounding area to be simulated. For instance, overlaid dynamic inputs can be activated depending on the position in space of the cabin relative to positional features of the scenario (e.g. buildings, sloped ground) as registered on an electronic map of the training area. Alternatively, they can be activated time dependently, upon input command by master user (trainer), or randomly, in each case e.g. for simulating changing wind conditions. In an embodiment of the present invention, the relative strength of dynamic inputs and hence emphasis and/or difficulty of the flight training session may be selected among plural operating modes. The motion range of the hover simulator can be limited by spatial limitations adapted to the training ground (“virtual fence”) or to avoid collisions with other objects, programmed in the simulation software and supported by additional sensors as necessary.

As an example of combined effects, in the flight situation illustrated in FIG. 10, which could be simulated on the training area shown in FIG. 11 as indicated by the arrow thereon, a sidewind effect might be added at point b of FIG. 10c. Such effect would abruptly move the cabin sideward as part of a roll movement, which requires an extended movement in a second horizontal direction. In such case, it is of particular benefit if the self-driven support vehicle can move both forward and sideward as illustrated in FIG. 3, preferably without intermediate rotating.

Moreover, according to an embodiment in which the cabin 10 comprises a window 11, 12 for viewing outside, at least one of a liquid sprinkler, an air blower, a dust generator and a fog generator for simulating environmental conditions outside the cabin 10 is mounted to the outside of the cabin 10, the robot arm 20, the support vehicle 30, or at a stationary position outside the aircraft simulating apparatus.

Such simulation of environmental conditions includes simulation of effects caused by the operations of the flight control such as brownout or whiteout resulting from downwash of a rotor during a landing operation of a helicopter on dusty or snowy ground, respectively.

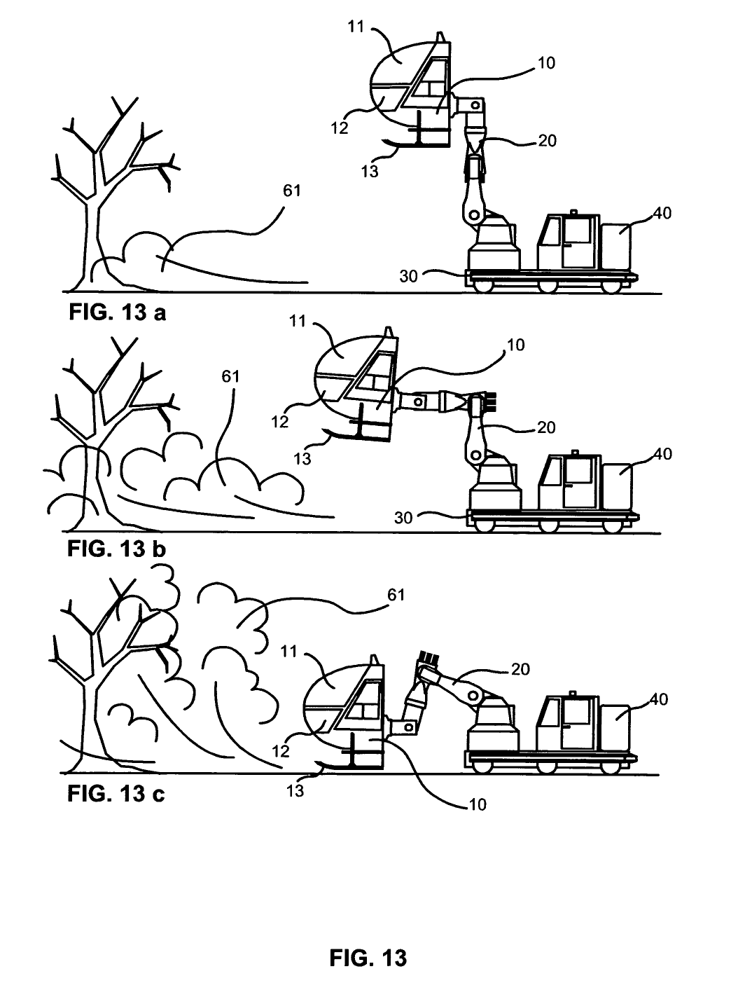

FIG. 13 illustrates side views of plural operation states of the aircraft simulating apparatus according to this embodiment.

In FIG. 13a, it is shown an operation state simulating a cabin 10 of a helicopter in a height of about 15 ft, approaching for landing on a ground covered by dust 61.

When further reducing height to e.g. 10 ft as shown in FIG. 13b, the downwash of the helicopter (groundward air stream supporting the helicopter against gravity) may create an unstable hover flight situation and produce a dust cloud which reduces visibility such that small objects on the ground may be overlooked. In the aircraft simulating apparatus, such dust cloud can be simulated by the above mentioned air blower or dust generator.

In FIG. 13c, the cabin 10 has almost reached ground and the simulated dust cloud is creating a situation, in which the pilot is forced to perform a blind landing, solely based on his body feeling, sense of balance, and orientation in space. As further shown in FIG. 13c, the carrying portion 20, 30 is configured to allow the cabin 10 to touch ground on a side of the support vehicle 30 so as to actually simulate full landing and take-off operations.

Hence, the aircraft simulating apparatus according to the present invention allows highly realistic simulation in particular of helicopter hover flights without virtual reality simulation.

Although the first aspect of this invention has been described with reference to the aforementioned embodiment, the present invention is not limited thereto, but is defined by the subsequent claims.

Other Aspect: Self-Driven Transport Apparatus

According to a second aspect, a self-driven transport apparatus is provided. A self-driven transport apparatus for moving an object along translational movements in three spatial directions and rotational movements around axes in three spatial directions comprises a self-driven support vehicle adapted to perform movement on a ground surface in forward and sideward directions, a robot arm supported by the support vehicle and adapted to hold and move an object to be transported, and a power supply unit comprising a fuel container and power source means for generating power to drive the support vehicle and the robot arm, from fuel contained in the fuel container.

This apparatus provides unlimited ground movements with all six degrees of motional freedom. It is fuel driven to provide good time of operation and physical range of operation. In particular, such apparatus is capable of implementing motions with very high degrees of freedom without necessity of handover and overextended operation time.

In this aspect, a self-driven transport apparatus for moving an object along translational movements in three spatial directions and rotational movements around axes in three spatial directions is provided. The apparatus according to this second aspect of the invention comprises a self-driven support vehicle 30 adapted to perform movement on a ground surface in forward and sideward directions, a robot arm 20 supported by the support vehicle and adapted to hold and move an object to be transported, and a power supply unit 40 comprising a fuel container and power source means for generating power to drive the support vehicle 30 and the robot arm 20, from fuel contained in the fuel container.

Such self-driven transport apparatus overcome the afore described drawbacks of the prior art when facing a task of transporting heavy objects along distances exceeding the size of transport equipment used and also performing complex movements. Merely for illustrative purposes, such complex movements might include moving a (heavy) object along a large helical trajectory, or moving a (heavy) object along an outer circumference of an irregularly curved surface while maintaining a predetermined distance and orientation thereto. In both cases, complexity might further increase if simultaneously average height over ground changes.

Such task can be accomplished by the transportation apparatus according to the present invention, which combines a self-driven vehicle supporting a robot arm so as to implement motions with six degrees of freedom. Moreover, the apparatus comprises a fuel container and power source means for generating, from fuel contained in the fuel container, power to drive the support vehicle and the robot arm, so as to achieve a large range of operation in terms of operating space and time. Although not limited thereto, such apparatus can use available or suitably adapted components, such as:

as the self-driven support vehicle:

Kuka omniMove, made by KUKA Roboter GmbH, Augsburg, Germany, see for example “Logistik and Verkehr in Bayern” (28 Mar. 2011), pages 36-37;

or

Multidirectional CLAAS Drive X2, made by CLAAS Fertigungstechnik, Beelen, Germany, see for example Ex-Zeitschrift (2010), pages 63-65;

as the robot arm:

KR 1000 L750 titan, made by KUKA Roboter GmbH, Augsburg, Germany, see for example automation 6/11;

or

M-2000iA/900L, made by Fanuc Robotics Deutschland GmbH, Neuhausen a.d.F., Germany; and as the power source means:
P-i40-AS made by Phoenix GmbH, Vogelsburg i.K., Germany; MOS32DE, made by Mittronik GmbH, Mendig, Germany; or

As regards the carrying portion 20, 30 and power source means 40 of the aircraft simulating apparatus according to the present invention described before, any combination of the aforementioned components of the transportation apparatus can be used for the carrying portion for holding and moving the cabin 10 as the object to be moved, as illustrated in FIG. 4.

In reverse, for the transportation apparatus, any implementation of the carrying portion as explained for the preceding embodiment of the flight simulating apparatus may apply. For instance, the self-driven support vehicle as well as the robot arm may each be adapted to perform movements with translational and rotational degrees of freedom as illustrated in FIG. 2, i.e. the robot arm may by capable of forward, vertical, roll, pitch, and yaw movements, and the self-driven support vehicle may perform for ward, sideward and yaw movements. Similarly as in the preceding embodiment of the aircraft simulating apparatus according to the present invention, although not limited thereto, the robot arm can have a vertical range between 3000 mm and 7000 mm, a horizontal range between 2000 mm and 4000 mm, a weight in the range from 2000 kg to 4000 kg, power consumption in the range from 5 kW to 15 kW, and can allow rotations of more than 360°.

Motion of the self-driven support vehicle may be based on superposed rolling movements around axes in different directions as in FIG. 3, or may alternatively use an air cushion vehicle or a track vehicle. Like in the preceding embodiment of the aircraft simulating apparatus according to the present invention, although not limited thereto, the self-driven support vehicle can have a length in the range from 2400 mm to 4500 mm, a width in the range from 1000 mm to 3000 mm, a weight in the range from 2000 kg to 8000 kg, a load capacity in the range from 2500 kg to 8000 kg, preferably 5000 kg or more, and power consumption in the range from 10 kW to 50 kW.

Moreover, like in the preceding embodiment of the aircraft simulating apparatus according to the present invention, although not limited thereto, the transportation apparatus may be adapted to holding and moving objects with a length in the range from 1500 mm to 4000 mm, a width in the range from 700 mm to 2500 mm, a height in the range from 1500 mm to 3000 mm, and a weight in the range from 200 kg to 1000 kg.

And the power source means may comprise a fuel cell or an electric generator combined with a combustion engine or a turbine. The power supply unit may preferably provide a continuous power supply, and may further preferably comprise a rechargeable battery for balancing changes in power consumption. All components of the power source means are adapted for the intended maximum and average power usages.

Rather than supporting and holding a cabin for flight simulation, the robot arm of the transporting apparatus according to this aspect of the invention has means for supporting and holding an object to be moved.

Such means for supporting and holding the object may be adapted for also releasing the object to be moved, such as one or more elements selected from claws, clutches, forks, pincers or the like.

Additionally and or alternatively, objects to be moved may comprise tools in state of use, removably mounted to the robot arm. Such tools may relate to any application of robotics. Illustrative examples of such mounted tools may include tools for measurement and/or sensing (e.g. cameras), tools for material processing (e.g. for welding, surface polishing), or tools for guiding fluids (e.g. hoses, pipes).

Motion control of the transportation apparatus may be effected in one of plural modes described below:

First mode (“GPS mode”): The control interface may reside in a first position outside the apparatus in fixed in a global coordinate system. This is particularly suitable f or modeling and controlling a movement along a predetermined trajectory defined by the global coordinate system, such as the aforementioned example of a large helix with inclined axis. Such trajectory may be decomposed into movements of the support vehicle and the robot arm, which together provide necessary degrees of freedom of movement.

Second mode (“Driver mode”): Additionally or alternatively, the control interface may reside in a second position fixed relative to the support vehicle, for instance in a driver cabin mounted thereon in a manner such as illustrated by reference numeral 35 in FIG. 2. Such control mode is particularly suitable for transportation over larger distances under direct control of an operator acting as vehicle driver, without necessity of precise determination in advance of a trajectory of motion. In this mode, the driver effectively controls motions of the apparatus relative to a coordinate system moving with the support vehicle.

Third mode (“Pilot mode): Further additionally or alternatively, control may be effected with reference to a coordinate system fixed relative to an outer portion of the robot arm. An illustration thereof could be the pilot cabin of the flight simulator, although the operator cabin of the flight simulator is preferably replaced here by one or several cameras, distance sensors and/or other means for orientation, which all can be accommodated in the robot arm without interfering with the primary purpose of apparatus, such as supporting, holding and releasing an object. This control mode is particularly suitable for high precision movement over small distances where the precise trajectory of motion is not determined in advance. An example thereof might be the aforementioned movement of an object along an outer circumference of an irregularly curved surface while (precisely) maintaining a predetermined (small) distance and orientation thereto.

In this mode, motion may be controlled by an operator, provided with a “pilot perspective” by the aforementioned one or several cameras, distance sensors and/or other means for orientation. A user interface allows to input desired in this “pilot perspective”, i.e. with respect to the coordinate system fixed relative to the outer portion of the robot arm, and these desired movements are then decomposed into movements of the support vehicle and the robot arm, which together provide necessary degrees of freedom for movement. Alternatively, motion control may be performed by a controller adapted to receive and process signals from the one or several cameras, distance sensors and/or other means for orientation, and to determine therefrom desired movements, which are subsequently decomposed into movements of the support vehicle and the robot arm.

More generally, the above modes may be described as a first mode of determining a trajectory along which the object is to be moved relative to a global coordinate system and decomposing the trajectory into movements to be respectively executed by the support vehicle and the robot arm; a second mode in which an operator uses a control interface provided in a position fixed relative to the support vehicle to control motions of the apparatus relative to a coordinate system moving with the support vehicle; and a third mode in which control is effected with reference to a coordinate system fixed relative to an outer portion of the robot arm, said arm accommodating one or several cameras, distance sensors and/or other means for orientation to output signals to be used for determining a desired movement, which is subsequently decomposed into movements to be respectively executed by the support vehicle and the robot arm.

The transportation apparatus may be equipped with control means allowing motion control in more than one of the aforementioned three control modes. In such case, the apparatus further comprises a selection means for allowing a user to select one of the available modes.

Also the flight simulating apparatus according to the first aspect of the present invention may preferably be adapted for use of a plurality of the afore-described control modes: The user interface with operating means adapted for simulating flight controls located in cabin supported and moved by the carrying portion is operable in the aforementioned pilot mode, and aforementioned driver modes and/or GPS modes can be available to other users such as flight instructor or supervisor via corresponding other interfaces.

For applications where the range of operation may be limited, the aforementioned operating modes may also be provided for a transportation apparatus comprising a support vehicle with a robot arm providing degrees of freedom necessary for translational movements in three spatial directions and rotational movements around axes in three spatial directions, but using an alternative power source other than the aforementioned power source means for generating power to operate the support vehicle and the robot arm from fuel contained in a fuel container comprised in the apparatus.

What is claimed is:

1. An aircraft simulating apparatus for helicopter hover simulation, comprising
a cabin containing in its interior a user interface with operating means adapted for simulating flight controls and at least one seat to accommodate a user in a pilot position to operate the flight controls;
a carrying portion for supporting and moving the cabin;
and
a controller adapted to control movements of the cabin in accordance with a hover simulation characteristics and dependent on the operation of the operating means for simulating flight controls;
characterized in that in that
the carrying portion is adapted to move the cabin along translational movements in three spatial directions (X, Y, Z) and rotational movements around axes in three spatial directions (X, Y, Z), and includes
a self-driven support vehicle adapted to perform movement on a ground surface at least along a forward direction (X′) and around one rotation axis (Z′) for rotating the forward direction (X′), and
a robot arm supported by the support vehicle to be moved therewith while holding and supporting the cabin.

2. The aircraft simulating apparatus according to claim 1, having mounted thereto a power supply unit comprising a fuel container and power source means for generating power to operate the support vehicle and the robot arm from fuel contained in the fuel container.

3. The aircraft simulating apparatus according to claim 2, wherein the support vehicle is adapted to further perform sideward (Y′) movements.

4. The aircraft simulating apparatus according to claim 3, wherein the robot arm is capable of translational movements along a forward (X″), and a vertical (Z″) direction, and rotational movements around axes in three spatial directions (X″, Y″, Z″).

5. The aircraft simulating apparatus according to claim 4, wherein the carrying portion is configured to allow the cabin to touch ground on a side of the support vehicle so as to simulate landing and take-off.

6. The aircraft simulating apparatus according to claim 5, wherein
the cabin comprises a window for viewing outside;
the pilot seat, the window and the robot arm are arranged such that a connection between robot arm and cabin is not visible from the seat through the window, and
the outside of the cabin is optionally shaped in correspondence with the aircraft to be simulated.

7. The aircraft simulating apparatus according to claim 6, wherein
the aircraft to be simulated is a helicopter;
the flight controls comprise cyclic stick, yaw pedals, and
collective pitch; and
the outside of the cabin optionally comprises skids and/or fuel probes.

8. The aircraft simulating apparatus according to claim 7, further comprising master control means adapted to override control by user operation of the operating means for simulating flight controls so as to confine forward and sideward movements of the support vehicle to a predetermined territory and/or confining rotational movements so as to prevent the transport apparatus from tilting.

9. The aircraft simulating apparatus according to claim 8, wherein the controller is adapted to affect the movement of the cabin dependent on at least one of simulated aircraft characteristics, simulated malfunctions, and simulated aerodynamic environment.

10. The aircraft simulating apparatus according to claim 9, further having mounted to the apparatus at least one of a liquid sprinkler, an air blower, a dust generator and a fog generator, for simulating environmental conditions outside the cabin; wherein the cabin comprises a window for viewing outside.

11. The aircraft simulating apparatus according to claim 10, configured such that the simulation of environmental conditions includes simulation of effects caused by the operations of the flight control.

12. The aircraft simulating apparatus according to claim 1, wherein the cabin comprises a screen for virtual outside view.

13. The aircraft simulating apparatus according to claim 12, wherein the hover simulation characteristics comprises at least one of the following:
in the absence of any operation of the operation means, movement of the cabin is effected, and
a predetermined operation of the operation means for movement in a certain direction causes movement of the cabin in a further direction.

14. The aircraft simulating apparatus according to claim 1, wherein the hover simulation characteristics comprises at least one of the following dynamic inputs:
vertical downward movement, for simulating loss of lift between large objects or above small ground elevations;
vertical upward movement, for simulating increase of lift close to ground;
roll of the cabin in combination with sideward drift for simulating side wind or sloped ground;
a sequence of downward and upward pitch, or upward and downward pitch, of the cabin, for simulating flight passing close to a large object such as a building; and
a combination of half turn roll and yaw of the cabin, for simulating uncorrected take-off.

15. The aircraft simulating apparatus according to claim 14 configured such that the movements of the cabin are performed by a combination of simultaneous movements of the robot arm and the support vehicle.
